(19) United States
(12) Patent Application Publication
(10) Pub. No.: US 2025/0377450 A1
(43) Pub. Date: Dec. 11, 2025

(54) SENSOR SYSTEM DISPOSED IN MOVING DEVICE AND METHOD OF CONTROLLING A PLURALITY OF SENSORS INCLUDED IN SENSOR SYSTEM

(71) Applicant: SAMSUNG ELECTRONICS CO., LTD., SUWON-SI (KR)

(72) Inventors: Junseong Kim, Suwon-si (KR); MINGOO KIM, Suwon-si (KR); Kyungwoo Yoo, Suwon-si (KR); Sangmin Yoo, Suwon-si (KR); HYUNG SUN LIM, Suwon-si (KR); DOOSEOK CHOI, Suwon-si (KR); Joonhoi Hur, Suwon-si (KR)

(21) Appl. No.: 19/169,215

(22) Filed: Apr. 3, 2025

(30) Foreign Application Priority Data
Jun. 5, 2024 (KR) 10-2024-0073755

(51) Int. Cl. G01S 13/86; G01S 13/32; G01S 13/89; G01S 19/22

(52) U.S. Cl. CPC G01S 13/86; G01S 13/32; G01S 13/89; G01S 19/22

(57) ABSTRACT

A sensor system disposed in a moving device includes a first sensor and a second sensor configured to monitor a surrounding area of the moving device and a processor configured to exchange data with the first sensor and the second sensor through a first wire. The processor may be configured to obtain first sensing data from the first sensor through the first wire, obtain second sensing data from the second sensor through the first wire, determine a state of the surrounding area based, at least in part, on the first sensing data, the second sensing data, and/or control the first sensor based on the state of the surrounding area.

### CROSS-REFERENCE TO RELATED APPLICATION(S)

This U.S. non-provisional application claims priority under 35 USC § 119 to Korean Patent Application No. 10-2024-0073755, filed on Jun. 5, 2024, in the Korean Intellectual Property Office, the disclosure of which is herein incorporated by reference in its entirety.

### TECHNICAL FIELD

The present disclosure relates to a sensor system and, more specifically, to a sensor system disposed in a moving device and a method of controlling a plurality of sensor included in the sensor system.

### DISCUSSION OF THE RELATED ART

In various information technology (IT) systems, sensors may be used to obtain data from environments thereof. Sensors may include, for example, cameras or other forms of image sensors, temperature sensors, pressure sensors, humidity sensors, audio sensors, or the like.

Sensor fusion is the process of combining data from multiple sensors to produce an accurate and reliable set of information. Sensor fusion technology has application in such fields as robotics, autonomous vehicles, unmanned aerial vehicles (for example, drones), and smart devices.

For example, technology to combine data from cameras, radar, LiDAR, and sonar sensors and accurately detect surrounding environments of vehicles is being used in the field of autonomous vehicles.

In addition, technology to combine data from sensors such as global positioning systems (GPS), accelerometers, and gyroscopes and provide more accurate location estimation and orientation detection is being used in the field of smart devices.

### SUMMARY

A sensor system disposed in a moving device includes a first sensor and a second sensor, each configured to monitor a surrounding area of the moving device, and a processor configured to exchange data with the first sensor and the second sensor through a first wire. The processor is configured to obtain first sensing data from the first sensor through the first wire, obtain second sensing data from the second sensor through the first wire, determine a state of the surrounding area based, at least in part, on the first sensing data and/or the second sensing data, and control the first sensor based on the state of the surrounding area.

A method of controlling a plurality of sensors disposed in a moving device includes obtaining first sensing data for a surrounding area of the moving device from a first sensor through a first wire. Second sensing data is obtained for the surrounding area from a second sensor through the first wire. A state of the surrounding area is determined based, at least in part, on the first sensing data and/or the second sensing data. An operation of the first sensor is controlled based on the state of the surrounding area.

A sensor system disposed in a moving device includes a plurality of sensors, each configured to monitor a surrounding area of the moving device, and a processor configured to control an operation of each of the plurality of sensors. The processor is configured to obtain sensing data from each of the plurality of sensors, determine a state of the surrounding area based on the sensing data, and control an operation of a first sensor, among the plurality of sensors, based on the state of the surrounding area.

### BRIEF DESCRIPTION OF DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating a sensor system, according to an example embodiment.

FIG. 2 is a schematic diagram illustrating a sensor system disposed in a moving device, according to an example embodiment.

FIG. 3 is a block diagram of a sensor system, according to an example embodiment.

FIG. 4A is a circuit diagram of a first sensor operating at low power, according to an example embodiment.

FIG. 4B is a circuit diagram of a first sensor operating robustly against signal interference, according to an example embodiment.

FIG. 5A is a perspective diagram illustrating a configuration to identify at least one object included in a surrounding area, according to an example embodiment.

FIG. 5B is a perspective diagram illustrating a configuration to identify at least one object included in a surrounding area, according to an example embodiment.

FIG. 6 is a perspective diagram illustrating a configuration to identify an area, in which density of an identified object is greater than or equal to a threshold value, in a surrounding area, according to an example embodiment.

FIG. 7 is a block diagram illustrating a configuration of a sensor system, according to an example embodiment.

FIG. 8 is a map diagram illustrating satellite data obtained through a second sensor, according to an example embodiment.

FIG. 9 is a flowchart illustrating a method of controlling a plurality of sensors included in a sensor system, according to an example embodiment.

FIG. 10 is a flowchart illustrating a method of determining a state of a surrounding area, according to an example embodiment.

FIG. 11 is a flowchart illustrating a method of determining a state of a surrounding area to control a first sensor, according to an example embodiment.

FIG. 12 is a flowchart illustrating a method of controlling a first sensor based on sensing data, according to an example embodiment.

FIG. 13A is a block diagram illustrating a sensor system, according to an example embodiment.

FIG. 13B is a schematic diagram illustrating the sensor system of FIG. 13A disposed in a moving device, according to an example embodiment.

### DETAILED DESCRIPTION

Hereinafter, example embodiments will be described with reference to the accompanying drawings.

The terms, such as “first,” “second,” or the like, may represent various elements regardless of order and/or importance. Such terms may be used to distinguish one element from another element, and do not necessarily limit the order and/or importance of the elements.

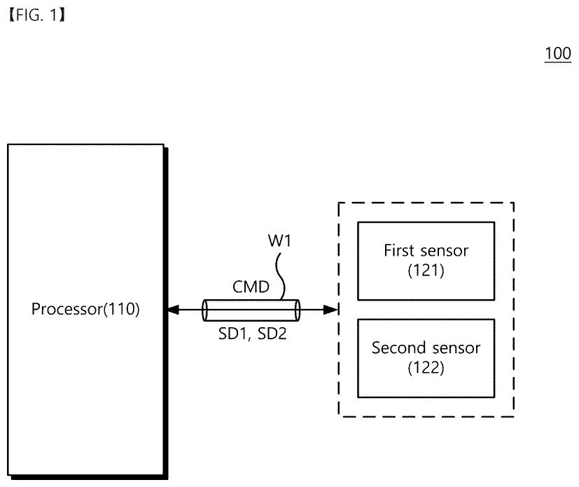

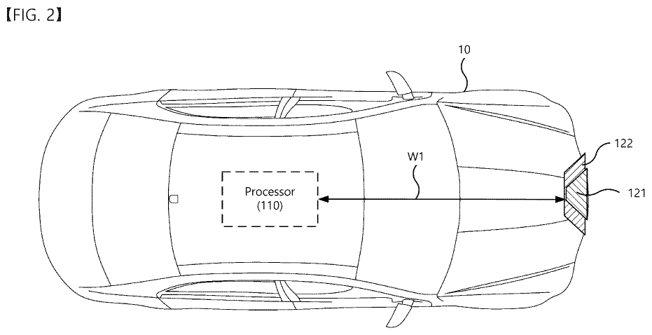

FIG. 1 is a block diagram of a sensor system, according to an example embodiment, and FIG. 2 is a schematic diagram illustrating a sensor system disposed in a moving device, according to an example embodiment.

Referring to FIG. 1, a sensor system 100, according to an example embodiment, may include a first sensor 121, a second sensor 122, and a processor 110. Referring to FIG. 2, the sensor system 100 may be disposed in a moving device 10.

The moving device 10 may be referred to as, for example, a vehicle. Alternatively, the moving device 10 may be referred to as an unmanned aerial vehicle (for example, a drone) or a robot.

For example, the type and configuration of the moving device 10 are not necessarily limited to the above-mentioned examples and may be understood as various movable devices.

For example, referring to FIGS. 1 and 2, the sensor system 100 may include a first sensor 121 and a second sensor 122, each disposed on a surface of the moving device 10.

The sensor system 100 may include a first sensor 121 and a second sensor 122 that monitor a surrounding area of the moving device 10.

The first sensor 121 may monitor a surrounding area of the moving device 10 to generate first sensing data SD1, and the second sensor 122 may monitor a surrounding area of the moving device 10 to generate second sensing data SD2.

Each of the first sensor 121 and the second sensor 122 may be a radar, a light detection and ranging (LiDAR) device, an image sensor (or a camera), an inertial measurement unit (IMU), an odometer, and/or a sonar sensor.

For example, the first sensor 121 may include a radar. Therefore, the first sensor 121 may generate electromagnetic waves in one direction in the surrounding area of the moving device 10. Also, the first sensor 121 may receive electromagnetic waves reflected from an object.

Thus, the first sensor 121 may detect a distance to an object present in the surrounding area of the moving device 10, a speed of the object, and a direction.

The second sensor 122 may include an image sensor. Therefore, the second sensor 122 may generate image data of a surrounding area of the moving device 10.

Referring to FIG. 2, the first sensor 121 and the second sensor 122 may be disposed adjacent to each other within a predetermined distance in the moving device 10.

For example, the first sensor 121 and the second sensor 122 may be disposed adjacent to each other within 30 cm in the moving device 10.

However, the types, operations, and arrangements of the first sensor 121 and the second sensor 122 are not necessarily limited to the above-mentioned examples and may be referred to as various components monitoring the surrounding area of the moving device 10.

In addition, the sensor system 100, according to an example embodiment, may include a processor 110 disposed inside the moving device 10.

For example, the processor 110 may obtain the sensing data SD1 and SD2 from the first sensor 121 and the second sensor 122, respectively, through a first wire W1. Also, the processor 110 may transmit a control signal CMD to the first sensor 121 or the second sensor 122 through the first wire W1.

For example, the processor 110 may be connected to the first sensor 121 and the second sensor 122, disposed adjacent to each other, through the first wire W1.

Also, the processor 110 may control the operation of the first sensor 121 and/or the second sensor 122 through the control signal CMD.

The processor 110 may execute software (or a program) to control at least one other component of the sensor system 100 (for example, the first sensor 121 or the second sensor 122) and perform various data processing or operations. Also, the processor 110 may include a central processing unit, a microprocessor, a system-on-chip, or the like, and may control the overall operation of the sensor system 100. Therefore, the operations performed by the sensor system 100 may be understood as being performed under the control of the processor 110.

According to an example embodiment, the processor 110 may determine a state of the surrounding area based, at least in part, on the first sensing data SD1 and/or the second sensing data SD2.

For example, the processor 110 may identify at least one object included in the surrounding area based, at least in part, on the first sensing data SD1 and/or the second sensing data SD2.

For example, the processor 110 may determine whether an object (for example, a vehicle) outputting an interference signal is present in the surrounding area with at least a predetermined threshold value, based on radar data and image data.

For example, the processor 110 may determine whether an object (for example, a person) having at least a predetermined threshold value is present in the surrounding area, based on image data.

Furthermore, the processor 110 may determine the state of the surrounding area based on the object identified in the surrounding area. The processor 110 may determine the state of the surrounding area based, at least in part, on the type, number, density, and/or size of the object identified in the surrounding area.

For example, the processor 110 may determine that the surrounding area is in a state, in which signal interference is present, when a number of vehicles greater than or equal to a threshold value are present in the surrounding area.

According to an example embodiment, the processor 110 may determine an area in which where the moving device 10 is present, based, at least in part, on the first sensing data SD1 and/or the second sensing data SD2.

For example, the processor 110 may determine whether the moving device 10 is present in a predetermined area (for example, an urban area), based on satellite data.

For example, the processor 110 may determine (or estimate) the state of the surrounding area of the moving device 10 using the sensing data SD1 and SD2 obtained from the first sensor 121 and the second sensor 122, respectively.

Furthermore, the processor 110 may control at least one sensor based on the state of the surrounding area. For example, the processor 110 may output a control signal CMD to control the first sensor 121 based on the state of the surrounding area.

For example, the processor 110 may control the first sensor 121 based on the state of the surrounding area determined by the sensing data SD1 and SD2 obtained from the first sensor 121 and the second sensor 122.

For example, when the processor 110 determines that a vehicle having at least a threshold value is present in the surrounding area, the processor 110 may control the first sensor 121 to operate without regard to interference signals.

For example, when the processor 110 determines that a number of vehicles less than or equal to a threshold value is present in the surrounding area, the processor 110 may control the first sensor 121 to operate at low power.

For example, when the processor 110 determines that an object is present in a first area of the surrounding area with at least a threshold value, the processor 110 may control the first sensor 121 to obtain image data of the first area.

For example, when the processor 110 determines that an object having at least a predetermined threshold value is present in the surrounding area, the processor 110 may decrease a period in which the first sensor 121 obtains the first sensing data SD1 for the surrounding area.

For example, when the processor 110 determines that an object having at least a threshold value is present in the surrounding area, the processor 110 may increase a frequency at which the first sensor 121 obtains the first sensing data SD1 for the surrounding area.

For example, when the processor 110 determines that an object having no more than a threshold value is present in the surrounding area, the processor 110 may increase a period in which the first sensor 121 obtains the first sensing data SD1 for the surrounding area.

For example, when the processor 110 determines an object having no more than a threshold value is present in the surrounding area, the processor 110 may decrease a frequency at which the first sensor 121 obtains the first sensing data SD1 for the surrounding area.

Referring to the above configurations, the processor 110, according to an example embodiment, may determine or estimate the state of the surrounding area of the moving device 10 using the sensing data SD1 and SD2 obtained from the plurality of sensors 121 and 122, respectively.

Also, the processor 110 may control the operation of the first sensor 121 based on the state of the surrounding area of the moving device 10.

Thus, the sensor system 100 may efficiently control the operation of the first sensor 121. Furthermore, the sensor system 100 may increase the performance of the first sensor 121.

Accordingly, the sensor system 100, according to an example embodiment, may have increased performance.

In addition, referring to the above-described configurations, the processor 110, according to an example embodiment, may be connected to the first sensor 121 and the second sensor 122, disposed adjacently to each other, through a single interconnection (for example, the first wire W1).

As a result, the sensor system 100, according to an example embodiment, may significantly reduce the cost and area required for interconnection between the processor 110 and the sensors 121 and 122.

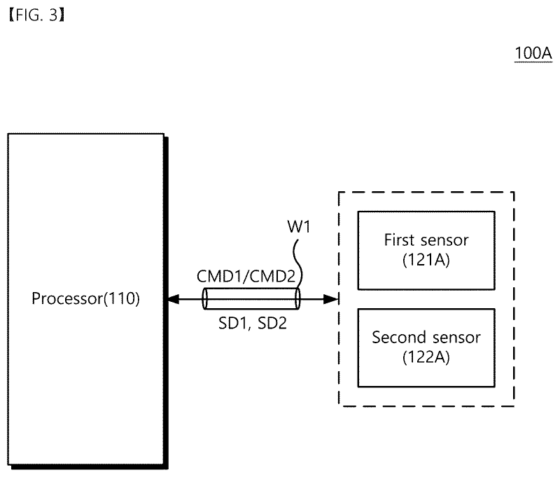

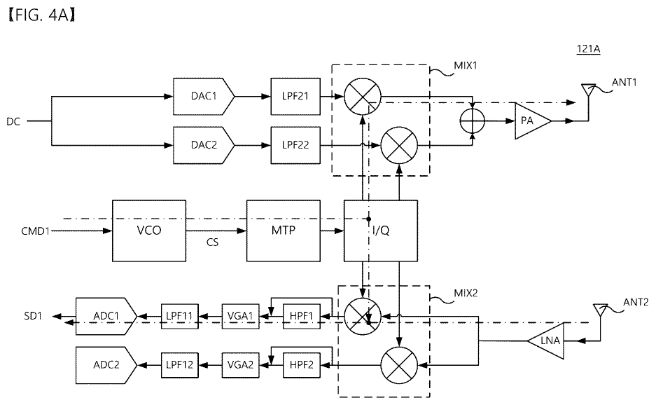

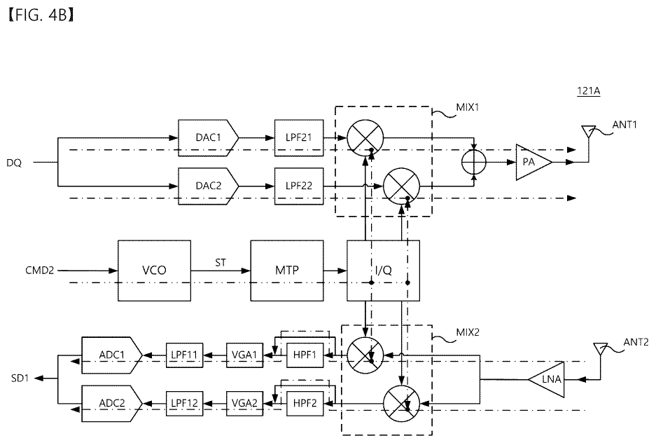

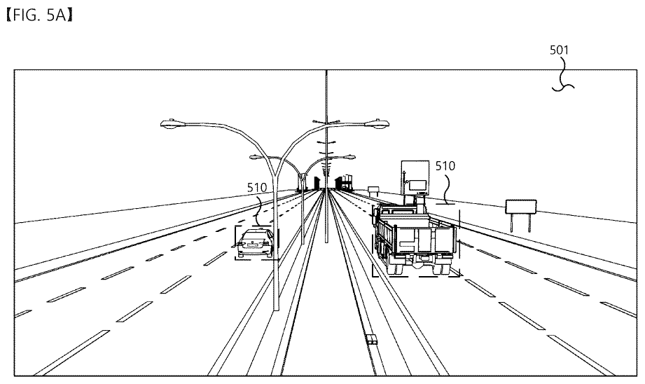

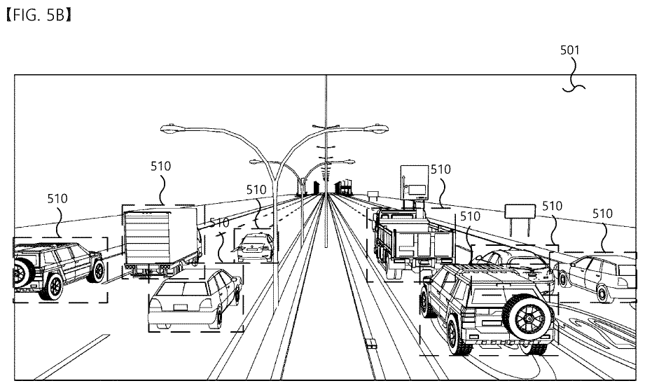

FIG. 3 is a block diagram of a sensor system, according to an example embodiment. FIG. 4A is a circuit diagram of a first sensor operating at low power, according to an example embodiment, and FIG. 4B is a circuit diagram of a first sensor operating robustly against signal interference, according to an example embodiment. FIG. 5A is a perspective diagram illustrating a configuration to identify at least one object included in a surrounding area, according to an example embodiment, and FIG. 5B is a perspective diagram illustrating a configuration to identify at least one object included in a surrounding area, according to an example embodiment.

Referring to FIG. 3, a sensor system 100A, according to an example embodiment, may include a first sensor 121A, a second sensor 122A, and a processor 110.

The sensor system 100A illustrated in FIG. 3 may be understood as an example of the sensor system 100 illustrated in FIG. 1. Therefore, to the extent that an element is not described in detail with respect to this figure, it may be understood that the element is at least similar to a corresponding element that has been described elsewhere within the present disclosure.

Referring to FIGS. 3, 4A, and 4B, a first sensor 121A, according to an example embodiment, may include a radar.

According to an example embodiment, the first sensor 121A may send electromagnetic waves to a surrounding area of a moving device 10 through a first antenna ANT1.

Also, the first sensor 121A may receive a signal, sent from the first antenna ANT1 that has been reflected by an object in the surrounding area, through a second antenna ANT2.

Furthermore, the first sensor 121A may generate first sensing data SD1 based on the signal received through the second antenna ANT2.

The first sensing data SD1 may be referred to as radar data.

According to an example embodiment, the first sensor 121A may identify at least one object present in the surrounding area of the moving device 10 using electromagnetic waves.

For example, the first sensor 121A may detect a distance to an object present in the surrounding area of the moving device 10, a speed of the object, and/or a direction using electromagnetic waves.

Referring to FIGS. 3, 5A, and 5B, the second sensor 122A, according to an example embodiment, may include an image sensor.

The second sensor 122A, according to an example embodiment, may have a field of view (FoV) 501 of a portion of the surrounding area of the moving device 10.

For example, the second sensor 122A may obtain image data of the FoV 501 in the surrounding area of the moving device 10.

Accordingly, the second sensing data SD2 generated from the second sensor 122A may be image data of the FoV 501 of the second sensor 122A.

According to an example embodiment, the processor 110 may identify at least one object present in the surrounding area of the moving device 10 based, at least in part, on the first sensing data SD1 and/or the second sensing data SD2.

Referring to FIGS. 4A to 5B, the processor 110, according to an example embodiment, may identify a plurality of objects 510 present in the surrounding area, based, at least in part, on the first sensing data SD1 and/or the second sensing data SD2.

For example, the processor 110 may identify a plurality of objects 510 present in the surrounding area, based on the radar data obtained from the first sensor 121A and the image data obtained from the second sensor 122A.

For example, each of the plurality of objects 510 may be referred to as a vehicle that is traveling on a road. However, for example, each of the plurality of objects 510 may be understood as a robot or an unmanned aerial vehicle. For example, the type of each of the plurality of objects 510 is not necessarily limited to the above-mentioned examples.

According to an example embodiment, the processor 110 may determine that the surrounding area is in a first state when the number of objects identified in the surrounding area is less than or equal to a predetermined first threshold value.

For example, referring to FIG. 5A, the processor 110 may determine that the surrounding area is in a first state when two vehicles, each having a threshold value less than or equal to the predetermined first threshold value (for example, “3”) are present in the surrounding area.

The first state may be understood as a state in which there is no signal interference caused by the plurality of objects 510 present in the surrounding area for the moving device 10.

According to an embodiment, the processor 110 may determine that the surrounding area is in a second state when the number of objects identified in the surrounding area is greater than a predetermined first threshold value.

For example, referring to FIG. 5B, the processor 110 may determine that the surrounding area is in a second state when eight vehicles having a threshold value greater than a predetermined first threshold value (for example, “3”) is present in the surrounding area.

The second state may be understood as a state in which there is signal interference caused by the plurality of objects 510 present in the surrounding area for the moving device 10.

Furthermore, the processor 110 may control the operation of the first sensor 121A based on the state of the surrounding area.

For example, the processor 110 may control the first sensor 121A to operate at low power in response to the surrounding area being in the first state.

For example, the processor 110 may control the first sensor 121A to operate in a frequency-modulated continuous wave (FMCW) mode, in which the first sensor 121A is capable of operating at low power, in response to the surrounding area being in the first state.

The processor 110 may control the first sensor 121A to operate in an FMCW mode, in which the first sensor 121A outputs a frequency-modulated signal, in response to the surrounding area being in the first state.

Referring to FIGS. 3 and 4A, the processor 110, according to an example embodiment, may transmit a first control signal CMD1 to the first sensor 121A such that the first sensor 121A operates in the FMCW mode.

For example, the processor 110 may transmit a first control signal CMD1 to the first sensor 121A such that the first sensor 121A generates a chirp signal CS internally. Also, the processor 110 may provide a DC input DC to the first sensor 121A.

According to an example embodiment, the first sensor 121A may generate a chirp signal CS through a voltage-controlled oscillator VCO in response to the first control signal CMD1. For example, the chirp signal CS may be understood as a signal having frequency and/or phase changing over time.

Also, the first sensor 121A may provide the chirp signal CS to a transmit mixer MIX1 and a receive mixer MIX2 through a frequency multiplier MTP and a modulation circuit I/Q, respectively.

According to an example embodiment, the signal provided to the transmit mixer MIX1 may be sent through the first antenna ANT1.

The signal received through the second antenna ANT2 may be combined with the signal, received from the modulation circuit I/Q, in the receive mixer MIX2.

Furthermore, the signal output from the receive mixer MIX2 may be input to a first analog-to-digital converter ADC1 through a first high-pass filter HPF1, a first variable gain amplifier VGA1, and a 1-1-th low-pass filter LPF11.

Also, the first sensing data SD1 converted into a digital signal through the first ADC ADC1 may be transmitted to the processor 110 through the first wire W1.

The first sensor 121A, according to an example embodiment, may operate at relatively low power when operating in FMCW mode.

Referring to the above-described configurations, the processor 110 may determine whether the number of vehicles identified in the surrounding area is less than or equal to a predetermined first threshold value, using the first sensor 121A and the second sensor 122A.

Furthermore, when the processor 110 determines that the number of vehicles identified in the surrounding area is less than or equal to a predetermined first threshold value, the processor 110 may control the first sensor 121A to operate at low power.

Thus, the sensor system 100, according to an example embodiment, may efficiently control the operation of the first sensor 121A depending on according to the state of the surrounding area of the moving device 10.

According to an example embodiment, the processor 110 may control the first sensor 121A to operate without regard to interference signals in response to the surrounding area being in the second state.

For example, the processor 110 may control the first sensor 121A to operate in a phase-modulated continuous wave (PMCW) mode or orthogonal frequency division multiplexing (OFDM) allowing the first sensor 121A to operate robustly against signal interference, in response to the surrounding area being in the second state.

Referring to FIGS. 3 and 4B, the processor 110, according to an example embodiment, may transmit a second control signal CMD2 to the first sensor 121A such that the first sensor 121A operates in PMCW mode or OFDM mode.

For example, the processor 110 may transmit a second control signal CMD2 to the first sensor 121A such that the first sensor 121A generates a single-tone signal ST. Also, the processor 110 may transmit data DQ, including waveform information, to the first sensor 121A.

According to an example embodiment, the first sensor 121A may generate a single-tone signal ST through a voltage-controlled oscillator VCO in response to the second control signal CMD2. The single-tone signal ST may be understood as a signal having a single frequency.

Also, the first sensor 121A may provide the single-tone signal ST to a transmit mixer MIX1 and a receive mixer MIX2 through a frequency multiplier MTP and a modulation circuit I/Q, respectively.

In addition, data DQ may be input to the transmit mixer MIX1 through a first digital-to-analog converter DAC1, a second digital-to-analog converter DAC2, a second low-pass filter LPF21, and a second low-pass filter LPF22.

The data DQ may be converted into a signal having a specific analog waveform by passing through the first DAC DACI and the second low-pass filter LPF21, or the second DAC DAC2 and the second low-pass filter LPF22.

The waveform generated from the data DQ may be mixed with the single-tone signal ST by the transmit mixer MIX1.

The signal mixed by the transmit mixer MIX1 may be sent through the first antenna ANT1 after passing through an amplifier PA.

A signal, received through the second antenna ANT2, may be combined with a signal, received from the modulation circuit I/Q, by the receive mixer MIX2.

A signal, output from the receive mixer MIX2, may be input to the first analog-to-digital converter ADC1 through the first variable gain amplifier VGA1 and the first low-pass filter LPF11. The signal, output from the receive mixer MIX2, may bypass the first high-pass filter HPF1.

A signal, output from the receive mixer MIX2, may be input to the second analog-to-digital converter ADC2 through the second variable gain amplifier VGA2 and the second low-pass filter LPF12. The signal, output from the receive mixer MIX2, may bypass the second high-pass filter HPF2.

The first sensing data SD1, converted into a digital signal through the first ADC ADC1 and the second ADC ADC2, may be transmitted to the processor 110 through the first wire W1.

The first sensor 121A, according to an example embodiment, may operate robustly against signal interference when operating in PMCW mode or OFDM mode. The first sensor 121A may operate without regard to interference signals when operating in PMCW mode or OFDM mode.

Referring to the above-described configurations, the processor 110 may determine whether the number of vehicles identified in the surrounding area is greater than a predetermined first threshold value, using the first sensor 121A and the second sensor 122A.

Furthermore, when the processor 110 determines that the number of vehicles identified in the surrounding area is greater than the predetermined first threshold value, the processor 110 may control the first sensor 121A to operate robustly against signal interference.

Thus, the sensor system 100, according to an example embodiment, may increase the performance of the first sensor 121A depending on the state of the surrounding area of the moving device 10.

Accordingly, the sensor system 100, according to an example embodiment, may efficiently control an individual sensor (for example, the first sensor 121A) based on the state of the surrounding area, determined by the plurality of sensors 121A and 122A, to increase the performance of each of the multiple sensors 121A and 122A.

As a result, the sensor system 100 may have increased performance.

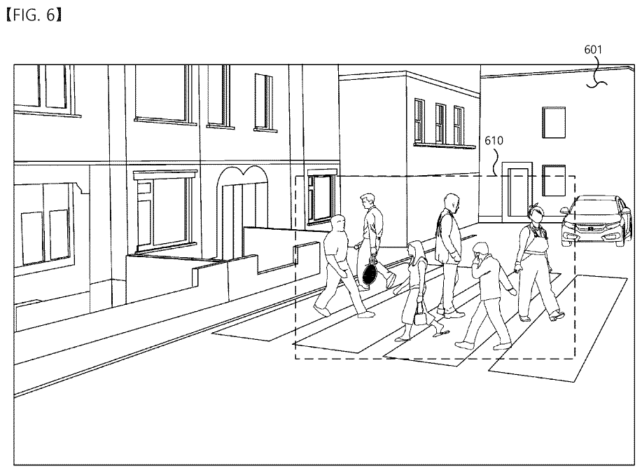

FIG. 6 is a diagram illustrating a configuration to identify an area, in which density of an identified object is greater than or equal to a threshold value, in a surrounding area, according to an example embodiment.

Referring to FIGS. 3 and 6, the processor 110, according to an example embodiment, may control the second sensor 122A to obtain image data of a certain area.

The processor 110 may obtain data for at least one object, present in the surrounding area, using the first sensor 121A and the second sensor 122A.

According to an example embodiment, the processor 110 may identify a person present in the surrounding area through the first sensor 121A including a radar.

Referring to FIG. 6, the processor 110, according to an example embodiment, may obtain image data for the FoV 601 of the second sensor 122A from the second sensor 122A including an image sensor.

According to an example embodiment, the processor 110 may identify the number, location, moving speed, and/or moving direction of a person existing in the surrounding area of the moving device 10 based on radar data and/or image data.

Also, the processor 110 may determine a first area 610, in which an object identified in the surrounding area has a density greater than or equal to a predetermined second threshold value, based, at least in part, on the first sensing data SD1 (for example, radar data) and/or the second sensing data SD2 (for example, image data).

For example, the processor 110 may determine a first area 610, in which persons are present at a density greater than or equal to a predetermined second threshold value, in the surrounding area of the moving device 10 based on radar data and image data.

In addition, the processor 110, according to an example embodiment, may control the second sensor 122A to obtain partial image data for the first area 610 in the FoV 601.

For example, when the processor 110 determines that persons are present at a density greater than or equal to the second predetermined threshold value in the first area 610, the processor 110 may control the second sensor 122A to obtain only partial image data for the first area 610 in the FoV 601.

The second sensor 122A may obtain partial image data for the first area 610 to have a relatively high resolution compared to a resolution when obtaining image data of the entire FoV 601.

According to an example embodiment, the processor 110 may control the second sensor 122A to obtain image data for the first area 610 in the FoV 601 at a first resolution.

Also, the processor 110 may control the second sensor 122A to obtain image data of an area, other than the first area 610 in the FoV 601, at a second resolution lower than the first resolution.

Referring to the above-described configurations, the processor 110 may control each sensor to obtain data for a specific area (for example, the first area 610) at a high resolution when a person is present at a density greater than a threshold in the specific area of the moving device 10.

Thus, the sensor system 100, according to an example embodiment, may increase the efficiency of the operation of each of the plurality of sensors 121A and 122A. Furthermore, the sensor system 100 may increase the performance of each of the plurality of sensors 121A and 122A.

As a result, the sensor system 100, according to an example embodiment, may have increased performance.

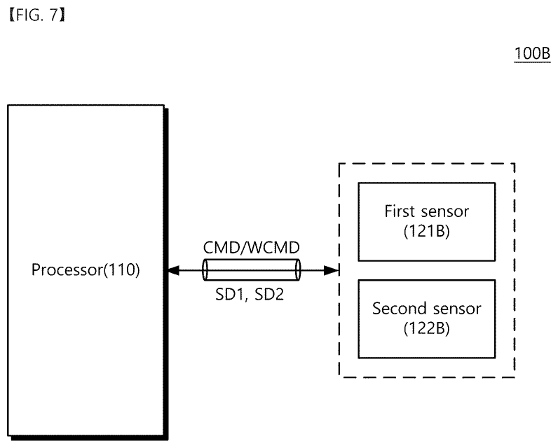

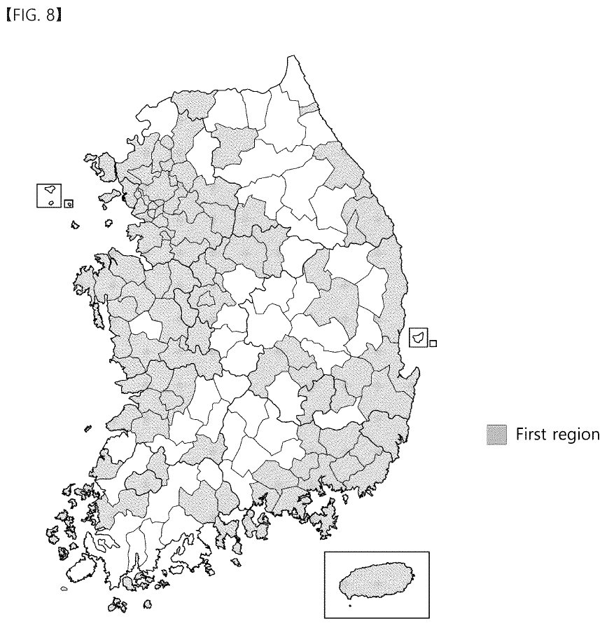

FIG. 7 is a block diagram illustrating a configuration of a sensor system, according to an example embodiment. FIG. 8 is a map diagram illustrating satellite data obtained through a second sensor, according to an example embodiment.

Referring to FIG. 7, a sensor system 100B, according to an example embodiment, may include a first sensor 121B, a second sensor 122B, and a processor 110.

The sensor system 100B illustrated in FIG. 7 may be understood as an example of the sensor system 100 illustrated in FIG. 1. Therefore, to the extent that an element is not described in detail with respect to this figure, it may be understood that the element is at least similar to a corresponding element that has been described elsewhere within the present disclosure.

According to an example embodiment, the first sensor 121B may include one of a radar, an image sensor, and a sonar sensor. However, the type of the first sensor 121B is not necessarily limited to the above-mentioned examples. For ease of description, an example is provided in which the first sensor 121B includes a radar.

Referring to FIGS. 7 and 8, the second sensor 122B, according to an example embodiment, may include a global positioning system (GPS) sensor or a global navigation satellite system (GNSS) sensor.

Accordingly, the second sensor 122B may obtain satellite data for the surrounding area in which the moving device 10 is present.

According to an example embodiment, the processor 110 may determine whether the moving device 10 is present within a first area, based on the first sensing data SD1 (for example, radar data) and/or the second sensing data SD2 (for example, satellite data).

For example, the processor 110 may determine whether the moving device 10 is present within the first area, based on satellite data.

For example, the processor 110 may determine whether the moving device 10 is present within the first area, based on image data and satellite data.

Referring to FIG. 8, for example, the first area may be understood as a city (or downtown) area in which a threshold or more of people, vehicles, unmanned aerial vehicles, or buildings are present.

In addition, for example, it may be preset whether each area according to an administrative district is a first area. In addition, for example, data on whether each area according to an administrative district is a first area may be stored in the processor 110.

However, the definition of the first area and the method of distinguishing the first area from other areas are not necessarily limited to the above-mentioned examples.

Furthermore, the processor 110 may determine a state of the surrounding area of the moving device 10 depending on whether the moving device 10 is present within the first area.

For example, the processor 110 may determine that the surrounding area is within the first area when the moving device 10 is not present within the first area.

Also, the processor 110 may determine that the surrounding area is in a second state when the moving device 10 is present within the first area.

The processor 110 may control the first sensor 121B or the second sensor 122B depending on whether the moving device 10 is present within the first area.

According to an example embodiment, the processor 110 may control a period, at which the first sensor 121B obtains the first sensing data SD1 for the surrounding area, depending on whether the moving device 10 is present within the first area.

For example, the processor 110 may decrease the period, at which the first sensor 121B obtains the first sensing data SD1 for the surrounding area, when the moving device 10 is present within the first area.

For example, the processor 110 may increase the period, at which the first sensor 121B obtains the first sensing data SD1 for the surrounding area, when the moving device 10 is not present within the first area.

According to an example embodiment, the processor 110 may control the operating mode of the first sensor 121B depending on whether the moving device 10 is present within the first area.

For example, when the moving device 10 is not present within the first area, the processor 110 may control the first sensor 121B including a radar to operate in an FMCW mode allowing the first sensor 121B to operate at low power.

For example, when the moving device 10 is present within the first area, the processor 110 may control the first sensor 121B including a radar to operate in PMCW mode or OFDM mode allowing the first sensor to operate robustly against signal interference.

Also, the processor 110, according to an example embodiment, may control the second sensing data SD2 obtained through the second sensor 122B depending on whether the moving device 10 is present within the first area.

For example, the processor 110 may control weights of signals constituting the second sensing data SD2 when the moving device 10 is present within the first area.

According to an example embodiment, when the second sensor 122B includes a GPS sensor or a GNSS sensor, the second sensing data SD2 may be referred to as first satellite data.

The first satellite data, according to an example embodiment, may include a first satellite signal and a second satellite signal.

For example, the first satellite signal and the second satellite signal may be understood as signals transmitted from different satellites. For example, the first satellite signal and the second satellite signal may be understood as different signals sequentially transmitted from the same satellite. However, the configuration of the first satellite signal and the second satellite signal constituting the first satellite data is not necessarily limited to the above-mentioned examples.

According to an example embodiment, the processor 110 may determine a first path error of the first satellite signal and a second path error of the second satellite signal when the moving device 10 is present within the first area.

For example, the processor 110 may determine the first path error of the first satellite signal and the second path error of the second satellite signal within the first area when the moving device 10 is present within the first area.

According to an example embodiment, when the first path error is greater than the second path error, the processor 110 may transmit a weight control signal WCMD to the second sensor 122B through the first wire W1.

For example, when the first path error is greater than the second path error, the processor 110 may control the weights applied to the first satellite signal and the second satellite signal.

According to an example embodiment, the second sensor 122B may apply a first weight to the first satellite signal in response to the weight control signal WCMD. Also, the second sensor 122B may apply a second weight, greater than the first weight, to the second satellite signal in response to the weight control signal WCMD.

Furthermore, the second sensor 122B may generate second satellite data using the first satellite signal, to which the first weight is applied, and the second satellite signal to which the second weight is applied.

Also, the second sensor 122B may transmit the generated second satellite data to the processor 110 through the first wire W1.

For example, when the moving device 10 is present within the first area, the processor 110 may decrease a weight for the satellite signal with a large path error within the first area. Also, the processor 110 may increase a weight for the satellite signal with a small path error within the first area.

Thus, the processor 110, according to an example embodiment, may increase the accuracy of location estimation through the GPS sensor or the GNSS sensor.

Referring to the above configurations, the processor 110 may control the operation of each of the plurality of sensors 121B and 122B depending on an area in which the moving device 10 is present.

Thus, the sensor system 100, according to an example embodiment, may increase the efficiency of the operation of each of the plurality of sensors 121B and 122B. Furthermore, the sensor system 100 may increase the performance of each of the plurality of sensors 121B and 122B.

Accordingly, the sensor system 100, according to an example embodiment, may have increased performance.

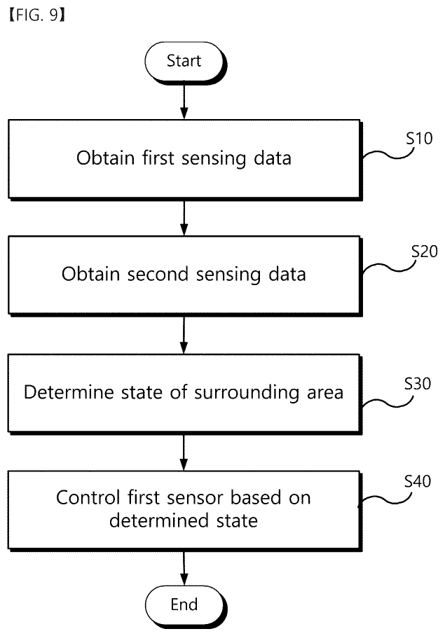

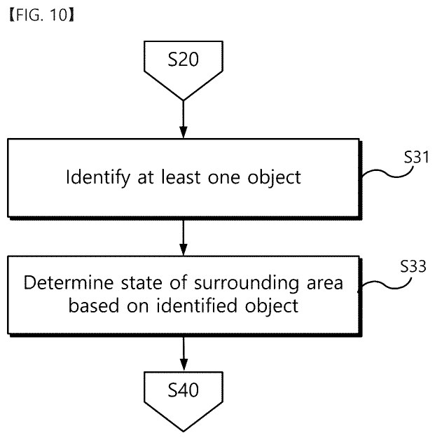

FIG. 9 is a flowchart illustrating a method of controlling a plurality of sensors included in a sensor system, according to an example embodiment. FIG. 10 is a flowchart illustrating a method of determining a state of a surrounding area, according to an example embodiment.

Referring to FIGS. 9 and 10, the processor 110 or the sensor system 100, according to an example embodiment, may determine the state of the surrounding area of the moving device 10 based on data obtained from the plurality of sensors 121 and 122. Furthermore, the processor 110 may control the first sensor 121 based on the state of the surrounding area.

In operation S10, the processor 110, according to an example embodiment, may obtain first sensing data SD1.

For example, the processor 110 may obtain the first sensing data SD1 from the first sensor 121 through the first wire W1.

The first sensing data SD1 may be understood as data obtained by the first sensor 121 by monitoring the surrounding area of the moving device 10.

In operation S20, the processor 110, according to an example embodiment, may obtain second sensing data SD2.

For example, the processor 110 may obtain the second sensing data SD2 from the second sensor 122 through the first wire W1.

The second sensing data SD2 may be understood as data obtained by the second sensor 122 by monitoring the surrounding area of the moving device 10.

According to an example embodiment, the first sensor 121 and the second sensor 122 may be disposed adjacent to each other within a predetermined distance. Also, the first sensor 121 and the second sensor 122 may exchange data with the processor 110 through a single first wire W1.

Thus, the sensor system 100, according to an example embodiment, may significantly reduce the cost and area for interconnection between the plurality of sensors 121 and 122 and the processor 110.

In operation S30, the processor 110, according to an example embodiment, may determine a state of the surrounding area.

For example, the processor 110 may determine the state of the surrounding area of the moving device 10 based, at least in part, on the first sensing data SD1 and/or the second sensing data SD2.

Referring to FIG. 10, the processor 110, according to an example embodiment, may determine the state of the surrounding area based on the number of objects identified in the surrounding area.

In operation S31, the processor 110 may identify at least one object. For example, the processor 110 may identify at least one object, present in the surrounding area, using the sensing data SD1 and SD2.

For example, the processor 110 may identify the number, moving direction, and/or moving speed of vehicles, present in the surrounding area of the moving device 10, based on radar data and image data.

For example, the processor 110 may identify the number, moving direction, density, and/or moving speed of people, present in the surrounding area of the moving device 10, based on image data and sonar data.

In operation S33, the processor 110 may determine the state of the surrounding area based on the identified object.

For example, the processor 110 may determine that the surrounding area of the moving device 10 is in a first state in which a number of vehicles less than a predetermined first threshold value are present, based on radar data and image data.

For example, the processor 110 may determine that the surrounding area of the moving device 10 is in a second state, in which a number of vehicles exceeding a predetermined first threshold value is present, based on image data and sonar data.

For example, the processor 110 may determine that the moving device 10 is present within the first area and the surrounding area is in a second state, based on satellite data.

For example, the processor 110 may determine the state of the surrounding area of the moving device 10 based on the sensing data SD1 and SD2 obtained from the plurality of sensors 121 and 122.

In operation S40, the processor 110, according to an example embodiment, may control the first sensor 121 based on the state of the surrounding area.

For example, the processor 110 may control the operation of the first sensor 121 based on the state of the surrounding area determined based on the sensing data SD1 and SD2.

According to an example embodiment, the processor 110 may control the period, at which the first sensor 121 obtains the first sensing data SD1 for the surrounding area, based on the state of the surrounding area of the moving device 10.

For example, the processor 110 may increase the period, at which the first sensor 121 obtains the first sensing data SD1 for the surrounding area, when the surrounding area is in the first state.

For example, the processor 110 may decrease the period, at which the first sensor 121 obtains the first sensing data SD1 for the surrounding area, when the surrounding area is in the second state.

According to an example embodiment, the processor 110 may control the operating mode of the first sensor 121 based on the state of the surrounding area of the moving device 10.

For example, when the surrounding area is in the first state, the processor 110 may control the first sensor 121 including a radar to operate in FMCW mode allowing the first sensor 121 to operate at low power.

For example, when the surrounding area is in the second state, the processor 110 may control the first sensor 121 including a radar to operate in PMCW mode or OFDM mode allowing the first sensor 121 to operate robustly against signal interference.

According to an embodiment, the processor 110 may control the operation of the first sensor 121 including an image sensor, based on the state of the surrounding area of the moving device 10.

For example, when the surrounding area is in the first state, the processor 110 may control the first sensor 121 to reduce the resolution of the first sensing data SD1.

For example, when the surrounding area is in the second state, the processor 110 may control the first sensor 121 to increase the resolution of the first sensing data SD1.

Referring to the above configurations, the processor 110 may control the operation of each of the plurality of sensors 121 and 122 based on the state of the surrounding area determined using the plurality of sensors 121 and 122.

Thus, the sensor system 100, according to an example embodiment, may increase the efficiency of the operation of each of the plurality of sensors 121 and 122. Furthermore, the sensor system 100 may increase the performance of each of the plurality of sensors 121 and 122.

As a result, the sensor system 100, according to an example embodiment, may have increased performance.

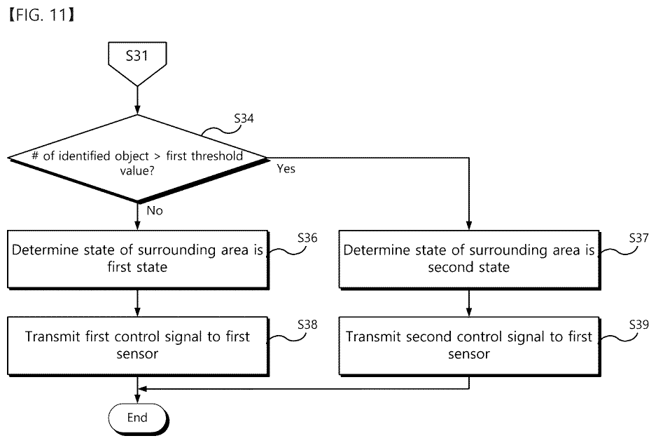

FIG. 11 is a flowchart illustrating a method of determining a state of a surrounding area to control a first sensor, according to an example embodiment.

Referring to FIG. 11, the processor 110, according to an example embodiment, may transmit different control signals CMD1 and CMD2 to the first sensor 121 based on the state of the surrounding area.

In operation S34, the processor 110, according to an example embodiment, may determine whether the number of objects identified in the surrounding area is greater than a predetermined first threshold value.

For example, the processor 110 may determine whether the number of objects identified in the surrounding area is greater than a predetermined first threshold value based on the sensing data SD1 and SD2.

For example, the object may be referred to as one of a vehicle, a person, a robot, and an unmanned aerial vehicle, but example embodiments are not necessarily limited thereto.

In operation S36, the processor 110 may determine that the surrounding area is in a first state. For example, the processor 110 may determine that the surrounding area is in the first state when the number of objects identified in the surrounding area is less than or equal to the predetermined first threshold value.

For example, the processor 110 may determine that the surrounding area is in the first state when two vehicles are present in the surrounding area, which is less than or equal to the predetermined first threshold value (for example, “3”).

For example, the first state may be understood as a state in which there is no signal interference caused by objects present in the surrounding area for the moving device 10.

In operation S38, the processor 110, according to an example embodiment, may transmit a first control signal CMD1 to the first sensor 121.

For example, the processor 110 may transmit a first control signal CMD1 to the first sensor 121 such that the first sensor 121 including a radar may operate in FMCW mode allowing the first sensor 121 to operate at low power, in response to the surrounding area being in the first state.

In operation S37, the processor 110, according to an example embodiment, may determine that the surrounding area is in a second state.

For example, the processor 110 may determine that the surrounding area is in the second state when the number of objects identified in the surrounding area is greater than the predetermined first threshold value.

For example, the processor 110 may determine that the surrounding area is in the second state when eight vehicles are present in the surrounding area, which is greater than the predetermined first threshold value (for example, “3”).

The second state may be understood as a state in which there is signal interference caused by objects present in the surrounding area for the moving device 10.

In operation S39, the processor 110, according to an example embodiment, may transmit a second control signal CMD2 to the first sensor 121.

For example, the processor 110 may transmit the second control signal CMD2 to the first sensor 121 such that the first sensor 121 including a radar may operate in PMCW mode or OFDM mode, which is robust against signal interference, in response to the surrounding area being in the second state.

Referring to the above configurations, the processor 110 may determine whether the number of objects identified in the surrounding area is greater than a predetermined first threshold value using the first sensor 121 and the second sensor 122.

Furthermore, the processor 110 may control the operation of the first sensor 121 based on whether the number of objects identified in the surrounding area is greater than the predetermined first threshold value.

Thus, the sensor system 100, according to an example embodiment, may increase the efficiency of the operation of each of the plurality of sensors 121 and 122. Furthermore, the sensor system 100 may increase the performance of each of the plurality of sensors 121 and 122.

As a result, the sensor system 100, according to an example embodiment, may have increased performance.

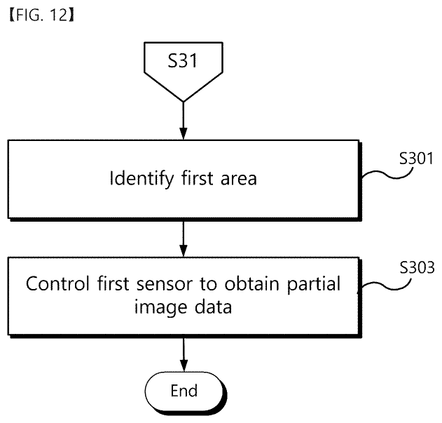

FIG. 12 is a flowchart illustrating a method of controlling a first sensor based on sensing data, according to an example embodiment.

Referring to FIG. 12, the processor 110, according to an example embodiment, may control the first sensor 121 to obtain data for a portion of a surrounding area based on objects identified in the surrounding area.

In operation S301, the processor 110, according to an example embodiment, may identify a first area.

For example, the processor 110 may determine a first area in which objects identified in the surrounding area have a density higher than or equal to a predetermined second threshold value.

For example, the processor 110 may determine a first area, in which there are persons at a density higher than or equal to a predetermined second threshold value, in the surrounding area of the moving device 10 based on radar data and image data.

In operation S303, the processor 110, according to an example embodiment, may control the first sensor 121 to obtain partial image data. An example is provided in which the first sensor 121 includes an image sensor.

For example, the processor 110 may control the first sensor 121 to obtain partial image data for the first area.

For example, when it is determined that there are persons at a density greater than or equal to the predetermined second threshold value in the first area, the processor 110 may control the first sensor 121 to obtain partial image data for the first area.

The first sensor 121 may obtain image data of the first area to have a relatively high resolution compared to when the first sensor 121 obtains image data for the entire FoV of the first sensor 121.

According to an example embodiment, the processor 110 may control the first sensor 121 to obtain image data for the first area in the FoV of the first sensor 121 at a first resolution.

In addition, the processor 110 may control the first sensor 121 to obtain image data for an area, other than the first area, in the FoV of the first sensor 121 at a second resolution lower than the first resolution.

Referring to the above-described configurations, the processor 110 may control each sensor to obtain data for a corresponding area at a high resolution when there are persons at a density greater than or equal to a threshold in the first area in the surrounding area of the moving device 10.

Thus, the sensor system 100, according to an example embodiment, may increase the efficiency of the operation of each of the plurality of sensors 121 and 122. Furthermore, the sensor system 100 may increase the performance of each of the plurality of sensors 121 and 122.

As a result, the sensor system 100, according to an example embodiment, may have increased performance.

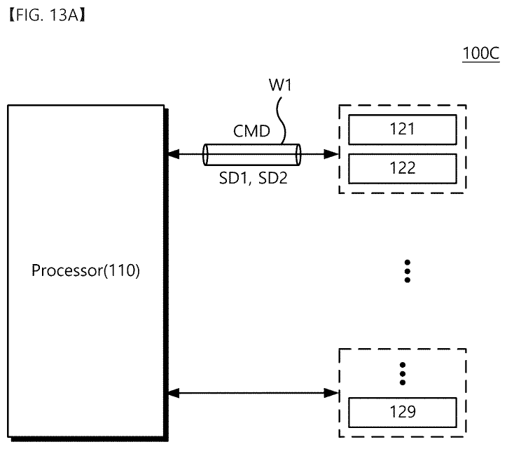

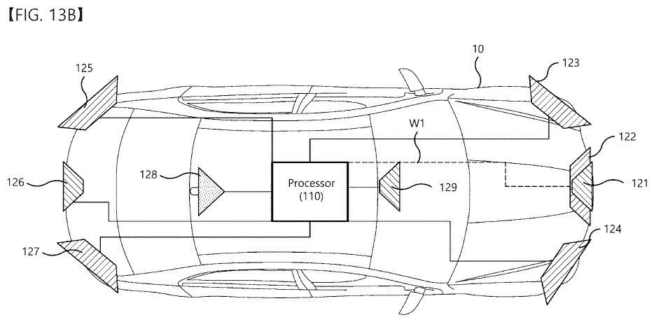

FIG. 13A is a block diagram illustrating a sensor system, according to an example embodiment, and FIG. 13B is a diagram illustrating the sensor system of FIG. 13A disposed in a moving device, according to an example embodiment.

Referring to FIGS. 13A and 13B, a sensor system 100C, according to an example embodiment, may include a processor 110 and a plurality of sensors 121 to 129.

The sensor system 100C illustrated in FIGS. 13A and 13B may be understood as an example of the sensor system 100 illustrated in FIG. 1. Therefore, to the extent that an element is not described in detail with respect to this figure, it may be understood that the element is at least similar to a corresponding element that has been described elsewhere within the present disclosure.

According to an example embodiment, the sensor system 100 may include a plurality of sensors 121 to 129 disposed on a moving device 10.

For example, the sensor system 100 may include a plurality of sensors 121 to 129 to monitor a surrounding area of the moving device 10.

For example, each of the first sensor 121, the sixth sensor 126, and the ninth sensor 129 may be referred to as an image sensor or a camera.

For example, each of the second sensor 122, the third sensor 123, the fourth sensor 124, the fifth sensor 125, and the seventh sensor 127 may be referred to as a radar.

For example, the eighth sensor 128 may be referred to as a GPS antenna or a radio-frequency (RF) antenna.

For example, the first sensor 121 may include a radar. Therefore, the first sensor 121 may detect a distance to an object present in the surrounding area of the moving device 10, moving speed of the object, and/or a moving direction using electromagnetic waves.

Also, the second sensor 122 may include an image sensor. Accordingly, the second sensor 122 may generate image data for the surrounding area of the moving device 10.

Referring to FIG. 13B, among the plurality of sensors 121 to 129, at least two sensors (for example, the first sensor 121 and the second sensor 122) may be disposed adjacent to each other within a predetermined distance from the moving device 10.

For example, the first sensor 121 and the second sensor 122 may be disposed adjacent to each other within 30 cm from the moving device 10.

For example, the third sensor 123 and the fourth sensor 124 may be disposed adjacent to each other within 1 m from the moving device 10.

However, the type, operation, and arrangement of each of the plurality of sensors 121 to 129 are not necessarily limited to the above-mentioned examples and may be referred to as various components to monitor the surrounding area of the moving device 10.

Also, the sensor system 100, according to an example embodiment, may include a processor 110 disposed inside the moving device 10.

For example, the processor 110 may obtain sensing data from each of the plurality of sensors 121 to 129.

For example, the processor 110 may obtain first sensing data SD1 and second sensing data SD2 from the first sensor 121 and the second sensor 122 through a first wire W1.

In addition, the processor 110 may transmit a control signal to each of the plurality of sensors 121 to 129 to control each of the plurality of sensors 121 to 129.

For example, the processor 110 may transmit a control signal CMD to the first sensor 121 or the second sensor 122 through the first wire W1.

The processor 110 may be connected to the first sensor 121 and the second sensor 122, disposed adjacent to each other, through a single first wire W1.

Thus, the sensor system 100, according to an example embodiment, may significantly reduce the cost and area required for interconnection between the processor 110 and the plurality of sensors 121 to 129.

According to an example embodiment, the processor 110 may determine a state of the surrounding area based, at least in part, on sensing data obtained from the plurality of sensors 121 to 129.

For example, the processor 110 may identify at least one object included in the surrounding area based, at least in part, on the sensing data obtained from the plurality of sensors 121 to 129.

For example, the processor 110 may determine whether a number of objects (for example, vehicles), each outputting an interference signal, greater than or equal to a predetermined threshold are present in the surrounding area, based on radar data and image data.

For example, the processor 110 may determine whether a number of objects (for example, persons) greater than or equal to a predetermined threshold value is present in the surrounding area, based on image data.

Furthermore, the processor 110 may determine the state of the surrounding area based on the object identified in the surrounding area. For example, the processor 110 may determine the state of the surrounding area based, at least in part, on the type, number, density, and/or size of objects identified in the surrounding area.

For example, the processor 110 may determine that the surrounding area is in a state in which signal interference is present, when a number of vehicles greater than a threshold value are present in the surrounding area.

Furthermore, the processor 110 may control at least one of the plurality of sensors 121 to 129 based on the state of the surrounding area.

The processor 110 may control the first sensor 121 based on the state of the surrounding area.

For example, when it is determined that a number of vehicles greater than a threshold value are present in the surrounding area, the processor 110 may control the first sensor 121 to operate without regard to interference signals.

For example, when it is determined that a number of vehicles less than or equal to a threshold value are present in the surrounding area, the processor 110 may control the first sensor 121 to operate at low power.

For example, when the processor 110 determines that a number of objects greater than a threshold value are present in the first area of the surrounding area, the processor 110 may control the first sensor 121 to obtain image data of the first area.

For example, when the processor 110 determines that a number of objects greater than or equal to a threshold value are present in the surrounding area, the processor 110 may decrease a period at which the first sensor 121 obtains the first sensing data SD1 for the surrounding area.

For example, when the processor 110 determines that a number of objects less than a threshold value are present in the surrounding area, the processor 110 may increase the period at which the first sensor 121 obtains the first sensing data SD1 for the surrounding area.

Referring to the above-described configurations, the processor 110, according to an example embodiment, may determine (or estimate) the state of the surrounding area of the moving device 10 using the sensing data obtained from the plurality of sensors 121 to 129.

In addition, the processor 110 may control the operation of at least one of the plurality of sensors 121 to 129 (for example, the first sensor 121) based on the state of the surrounding area of the moving device 10.

Thus, the sensor system 100, according to an example embodiment, may increase the efficiency of the operation of each of the plurality of sensors 121 to 129. Furthermore, the sensor system 100 may increase the performance of each of the plurality of sensors 121 to 129.

As a result, the sensor system 100, according to an example embodiment, may have increased performance.

As described above, the processor 110, according to an example embodiment, may control the operation of each of the plurality of sensors 121 and 122 based on the state of the surrounding area determined using the plurality of sensors 121 and 122.

Thus, the sensor system 100, according to an example embodiment, may increase the efficiency of the operation of each of the plurality of sensors 121 and 122. Furthermore, the sensor system 100 may increase the performance of each of the plurality of sensors 121 and 122.

As a result, the sensor system 100, according to an example embodiment, may have increased performance.

In addition, the processor 110, according to an example embodiment, may be connected to the first sensor 121 and the second sensor 122 disposed adjacent to each other through a single wiring (for example, the first wire W1).

As a result, the sensor system 100, according to an example embodiment, may significantly reduce the cost and area required for interconnection between the processor 110 and the sensors 121 and 122.

As set forth above, a sensor system, according to example embodiment, may have increased performance by efficiently controlling individual sensors based on a state of a surrounding area determined by a plurality of sensors.

While example embodiments have been shown and described above, it will be apparent to those skilled in the art that modifications and variations could be made without departing from the scope of the present inventive concept.

What is claimed is:

1. A sensor system disposed in a moving device, the sensor system comprising:
a first sensor and a second sensor, each configured to monitor a surrounding area of the moving device; and
a processor configured to exchange data with the first sensor and the second sensor through a first wire,
wherein the processor is configured to:
obtain first sensing data from the first sensor through the first wire;
obtain second sensing data from the second sensor through the first wire;
determine a state of the surrounding area based, at least in part, on the first sensing data and/or the second sensing data; and
control the first sensor based on the state of the surrounding area.

2. The sensor system of claim 1,
wherein the first sensor comprises a radar that is configured to transmit and receive electromagnetic waves,
wherein the processor is configured to transmit a first control signal to the first sensor through the first wire when the surrounding area is in a first state, and
wherein the radar is configured to operate in frequency-modulated continuous wave (FMCW) mode allowing a frequency-modulated signal to be output in response to the first control signal.

3. The sensor system of claim 2,
wherein the processor is configured to transmit a second control signal to the first sensor through the first wire when the surrounding area is in a second state different from the first state, and
wherein the radar is configured to operate in phase-modulated continuous wave (PMCW) mode, allowing a phase-modulated signal to be output in response to the second control signal, or orthogonal frequency division multiplexing (OFDM) mode.

4. The sensor system of claim 3,
wherein the second sensor comprises an image sensor, and
wherein the processor is configured to:
identify at least one object included in the surrounding area from image data obtained through the image sensor; and
determine a state of the surrounding area based on a number, a density, a type, and/or a size of objects identified in the surrounding area.

5. The sensor system of claim 4,
wherein the processor is configured to:
determine that the surrounding area is in the first state in response to a number of objects identified in the surrounding area being less than or equal to a predetermined first threshold value, and
determine that the surrounding area is in the second state in response to the number of objects identified in the surrounding area is greater than the predetermined first threshold value.

6. The sensor system of claim 5,
wherein the processor is configured to:
identify a first area, in which a density of objects identified is greater than or equal to a predetermined second threshold value, in the surrounding area based on the image data; and
control the second sensor to obtain partial image data for the first area.

7. The sensor system of claim 3,
wherein the second sensor comprises a global navigation satellite system (GNSS) sensor and/or a global positioning system (GPS) sensor, and
wherein the processor is configured to determine a state of the surrounding area based on first satellite data obtained through the second sensor.

8. The sensor system of claim 7,
wherein the processor is configured to:
determine whether the moving device is present within a first area based on the first satellite data;
determine that the surrounding area is in the first state when the moving device is not present within the first area; and
determine that the surrounding area is in the second state when the moving device is present within the first area.

9. The sensor system of claim 8,
wherein the first satellite data comprises a first satellite signal and a second satellite signal,
wherein the processor, when it is determined that the surrounding area is in the first state, is configured to:
determine a first path error of the first satellite signal and a second path error of the second satellite signal; and
transmit a weighting control signal to the second sensor via the first wire if the first path error is greater than the second path error, and
wherein the second sensor is configured to apply a first weight to the first satellite signal in response to the weighting control signal, and apply a second weight, greater than the first weight, to the second satellite signal to generate second satellite data.

10. The sensor system of claim 1, wherein the first sensor and the second sensor are disposed in the moving device, adjacent to each other within a predetermined distance.

11. A method of controlling a plurality of sensors disposed in a moving device, the method comprising:
obtaining first sensing data for a surrounding area of the moving device from a first sensor through a first wire;
obtaining second sensing data for the surrounding area from a second sensor through the first wire;
determining a state of the surrounding area based, at least in part, on the first sensing data and/or the second sensing data; and
controlling an operation of the first sensor based on the state of the surrounding area.

12. The method of claim 11,
wherein the determining the state of the surrounding area comprises:
identifying at least one object, included in the surrounding area, using the first sensing data and/or the second sensing data; and
determining the state of the surrounding area based on a number, a density, a type, and/or a size of objects identified in the surrounding area.

13. The method of claim 12,
wherein the determining the state of the surrounding area further comprises:
determining that the surrounding area is in a first state in response to the number of the objects identified in the surrounding area being less than or equal to a predetermined first threshold value; and
determining that the surrounding area is in a second state in response to the number of objects identified in the surrounding area being greater than the predetermined first threshold value.

14. The method of claim 13,
wherein the controlling the operation of the first sensor based on the state of the surrounding area comprises:
transmitting a first control signal to the first sensor such that the first sensor comprising a radar to operates in frequency-modulated continuous wave (FMCW) mode allowing a frequency-modulated signal to be output, when the surrounding area is in the first state; and
transmitting a second control signal to the first sensor such that the first sensor operates in phase-modulated continuous wave (PMCW) mode allowing a phase-modulated signal to be output, when the surrounding area is in the second state.

15. The method of claim 13,
wherein the controlling the operation of the first sensor based on the state of the surrounding area comprises:
identifying a first area, in which a density of identified objects is greater than a predetermined second threshold value, in the surrounding area; and
controlling the first sensor to obtain partial image data for the first area.

16. A sensor system disposed in a moving device, the sensor system comprising:
a plurality of sensors, each configured to monitor a surrounding area of the moving device; and
a processor configured to control an operation of each of the plurality of sensors,
wherein the processor is configured to:
obtain sensing data from each of the plurality of sensors;
determine a state of the surrounding area based on the sensing data; and
control an operation of a first sensor, among the plurality of sensors, based on the state of the surrounding area.

17. The sensor system of claim 16,
wherein the sensing data comprises radar data and image data, and
wherein the processor is configured to:
identify at least one object, included in the surrounding area, using the radar data and/or the image data, and
determine a state of the surrounding area based on a number, a density, a type, and/or a size of objects identified in the surrounding area.

18. The sensor system of claim 17,
wherein the processor is configured to:
determine that the surrounding area is in a first state in response to the number of objects, identified in the surrounding area, being less than or equal to a predetermined first threshold value, and
determine that the surrounding area is in a second state in response to the number of the objects, identified in the surrounding area, being greater than the predetermined first threshold value.

19. The sensor system of claim 18,
wherein the first sensor comprises a radar, and
wherein the processor is configured to:
control the first sensor to operate in in frequency-modulated continuous wave (FMCW) mode, allowing a frequency-modulated signal to be output, when the surrounding area is in the first state; and
control the first sensor to operate in phase-modulated continuous wave (PMCW) mode, allowing a phase-modulated signal to be output, when the surrounding area is in the second state.

20. The sensor system of claim 16, wherein the first sensor comprises a global navigation satellite system (GNSS) sensor, a global positioning system (GPS) sensor, an inertial measurement unit (IMU), an odometer, and/or a sonar sensor.
